(19) United States
(12) Patent Application Publication
(10) Pub. No.: US 2018/0260342 A1
(43) Pub. Date: Sep. 13, 2018

(54) MASS STORAGE DEVICE IOT SIDEBAND

(71) Applicant: Toshiba Memory Corporation, Tokyo (JP)

(72) Inventors: Senthil Murugan Thangaraj, San Jose, CA (US); Narasimhulu Dharani Kotte, San Jose, CA (US); Chayan Biswas, San Jose, CA (US); Robert Reed, San Jose, CA (US); Hitoshi Kondo, San Jose, CA (US)

(21) Appl. No.: 15/455,736

(22) Filed: Mar. 10, 2017

(51) Int. Cl. G06F 13/10; G06F 13/36

(52) U.S. Cl. CPC G06F 13/102; G06F 13/36

(57) ABSTRACT

A mass storage device and a method for wirelessly transmitting a first information by a mass storage device is disclosed. In one embodiment, the mass storage device includes one or more memory devices and a mass storage device controller communicatively coupled to the one or more memory devices. The mass storage device controller includes one or more controller processors and a wireless sideband interface. The wireless sideband interface is configured to wirelessly transmit the first information retrieved by an interface processor of the wireless sideband interface from one of the controller processors or one of the memory devices. In one embodiment, the interface processor is an internet-of-things (IoT) processor.

### FIELD OF THE INVENTION

This invention generally relates to information transmission and reception for mass storage devices.

### BACKGROUND OF THE INVENTION

Mass storage devices, such as solid-state drives (SSDs) and hard disk drives (HDDs), play vital roles in computer and enterprise data storage. Typically, mass storage devices are communicatively coupled to a host device, such as a personal computer or a mass storage appliance. During operation, in addition to its primary purpose of storing host data, these mass storage devices are capable of internally generating operating information related to the performance or operation of its internal components.

There are two conventional approaches for a mass storage device to communicate this type of information: (1) an in-band approach and (2) a wired sideband approach. The in-band approach relies on passing information through a communications interface between the mass storage device and the host. This is typically how a mass storage device carries out its routine operations, such as receiving data from the host for storage or returning stored data to the host. The communications interface may be an “in-band suitable interface,” for example, a Peripheral Component Interconnect Express (PCIe) interface, a Serial AT Attachment (SATA) interface, a Serial Attached (“SAS”) interface, a Small Computer System (SCSI) interface, or the like.

The wired sideband approach relies on passing information through a sideband interface of the mass storage device. These sideband ports may be, for example, a Joint Test Action Group (“JTAG”) interface, a Universal Asynchronous Receiver/Transmitter (“UART”) interface, and a System Management Bus (“SMBus”)/Inter-IC (“I2C”) interface. To communicate with the mass storage device via one of its sideband interfaces, a suitable device capable of communicating with the type of sideband interface must be used. The suitable device needs to be physically connected to the sideband interface of the mass storage device, and a custom software protocol must be executed in order to communicate with the mass storage device.

There are significant drawbacks to both the in-band and wired sideband approaches. First, both approaches require the mass storage device to be physically connected to an external device, either the host or a suitable device capable of communicating via an in-band suitable interface (for the in-band approach) or the sideband interface (for the wired sideband approach). This physical connection requirement limits the ability to monitor or manage a mass storage device in a remote location, or to monitor large numbers of mass storage devices simultaneously. Second, the types of information that can be accessed through this approach can be limited. For example, both approaches will not be able to access internally generated information if a controller of the mass storage device is non-operational. Third, for the in-band approach, accessing operating information in this manner takes away crucial bandwidth for normal data storage and retrieval operations that are carried out by the mass storage device over the communications interface.

Accordingly, there is an unmet demand for mass storage devices to externally communicate internally generated operating information in a manner that is more convenient and efficient.

### BRIEF DESCRIPTION OF THE INVENTION

In one embodiment, a mass storage device includes one or more memory devices and a mass storage device controller communicatively coupled to the one or more memory devices. The mass storage device controller includes one or more controller processors and a wireless sideband interface. The wireless sideband interface includes an interface processor in communication with at least one of the controller processors. In one embodiment, the mass storage device is an SSD. In another embodiment, the mass storage device is an HDD. In one embodiment, the wireless sideband interface processor is an internet-of-things (IoT) processor.

In one embodiment, the wireless sideband interface is configured to wirelessly transmit a first information retrieved by the interface processor from one of the controller processors or one of the memory devices. In one embodiment, the first information includes input/output (I/O) statistics of the mass storage device. In another embodiment, the first information includes error information of the mass storage device. In yet another embodiment, the first information includes a temperature information or a power consumption information of the mass storage device.

In one embodiment, the wireless sideband interface is further configured to wirelessly receive a second information and communicate the second information to one of the controller processors. In one embodiment, the wireless sideband interface is configured to encapsulate the first information in accordance with a wireless network protocol, and to decapuslate the second information in accordance with the wireless network protocol. In one embodiment, the wireless network protocol is a Message Queue Telemetry Transport (MQTT) protocol. In another embodiment, the wireless network protocol is a Constrained Application Protocol (CoAP). In yet another embodiment, the wireless network protocol is a Hypertext Transfer Protocol (HTTP).

In one embodiment, the second information includes one or more instructions and one of the controller processors is configured to execute the one or more instructions. In one embodiment, the mass storage device further includes one or more sensors in communication with the at least one of the controller processors or the wireless sideband interface. The wireless sideband interface may be configured to gather the first information from the one or more sensors.

In one embodiment, the mass storage device further includes a first power source and a second power source. The first power source is configured to provide power to the mass storage device and the second power source is configured to provide power to the wireless sideband interface.

In one embodiment, a method of wirelessly transmitting a first information by a mass storage device includes initializing a wireless sideband interface of a mass storage device controller of the mass storage device. The wireless sideband interface has an interface processor in communication with one or more controller processors of the mass storage device controller. The method further includes retrieving, by the interface processor, the first information from one of the controller processors within the mass storage device controller or one or more memory devices communicatively coupled to the mass storage device controller. The method further includes processing, by the interface processor, the first information for wireless transmission and transmitting, by the wireless sideband interface, the first information.

In one embodiment, the mass storage device is an SSD. In another embodiment, the mass storage device is an HDD. In one embodiment, the wireless sideband interface processor is an IoT processor. In one embodiment, the first information includes I/O statistics of the mass storage device. In another embodiment, the first information includes error information of the mass storage device. In yet another embodiment, the first information includes a temperature information or a power consumption information of the mass storage device.

In one embodiment, the method further includes wirelessly receiving, by the wireless sideband interface, a second information. The method further includes processing, by the wireless sideband interface, the second information, and communicating, by the interface processor, the second information to one of the controller processors. In one embodiment, the method further includes executing, by one of the controller processors, one or more instructions included in the second information.

In one embodiment, the step of processing the first information for wireless transmission includes encapsulating the first information in accordance with a wireless network protocol, and the step of processing the second information includes decapsulating the second information in accordance with the wireless network protocol. In one embodiment, the wireless network protocol is a MQTT protocol. In another embodiment, the wireless network protocol is a CoAP protocol. In yet another embodiment, the wireless network protocol is a HTTP protocol.

### BRIEF DESCRIPTION OF THE FIGURES

FIG. 1 is a block diagram of the structure of a mass storage device, according to one embodiment of the invention.

FIG. 2 is a block diagram of a mass storage device controller wirelessly communicating with a secure network through a wireless sideband interface, according to one embodiment of the invention.

FIG. 3 is a flowchart of method steps for performing a transmission and a reception operation using a wireless sideband interface of a mass storage device, according to one embodiment of the invention.

FIG. 4 is a flowchart of method steps for initializing a wireless sideband interface, according to one embodiment of the invention.

FIG. 5 is a flowchart of method steps for wirelessly receiving and processing information with a wireless sideband interface, according to one embodiment of the invention.

FIG. 6 is a block diagram of a plurality of mass storage devices communicating with a wireless network through respective wireless sideband interfaces, according to one embodiment of the invention.

### DETAILED DESCRIPTION OF THE INVENTION

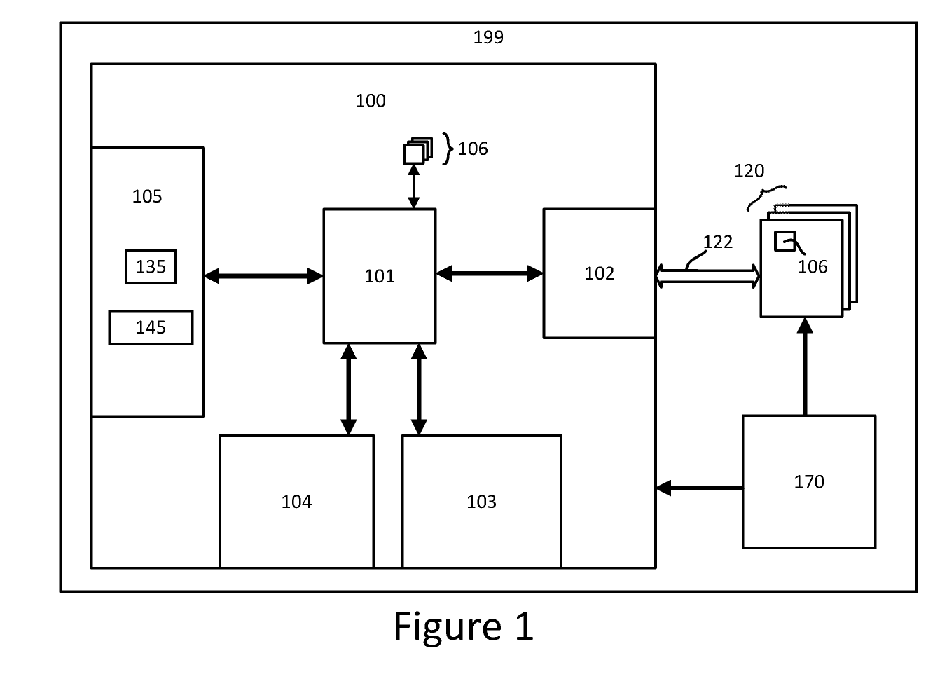

FIG. 1 is a block diagram of the structure of a mass storage device 199, according to one embodiment of the invention. The mass storage device 199 includes a mass storage device controller 100 and one or more memory devices 120 for data storage. The memory devices 120 may be any device capable of storing data, including volatile memory devices, non-volatile memory devices, and ferromagnetic or electromagnetic storage devices (i.e. HDD platters). In one embodiment, the mass storage device controller 100 may be a packaged integrated circuit (IC) device that includes a controller processor 101 and a memory controller 102 integrated within the mass storage device controller 100. The controller processor 101 may have one or more processor cores. The mass storage device controller processor 101 manages the operations of the memory devices 120 and communication with external devices over various interfaces packaged with the mass storage device controller 100, as explained in greater detail below.

The mass storage device controller 101 manages reading from and writing to the memory devices 120 via its memory controller 102. While a single memory controller 102 is shown in FIG. 1 for simplicity, the mass storage device controller 102 may have one or more memory controllers 102, and memory devices 120 can be arranged in one or more communications channels 122 that are communicatively coupled to the one or more memory controllers 102. The specific number of memory controllers 102, memory devices 120, and communications channels 122 are not limited, and may vary depending on the specific storage requirements of the mass storage device 199.

The mass storage device controller 100 may include a host interface 103 in communication with the controller processor 101. The mass storage device controller 100 may be configured to transmit to or receive information from a host (not shown) through the host interface 103. The host interface 103 may be a PCIe interface, the SATA interface, a SAS interface, a SCSI interface, or any other interface suitable for facilitating communication with the host. The host may comprise any suitable device, such as a computer or a mass storage appliance. As previously discussed, passing information between the host and the mass storage device 199 through the host interface 103 is typically referred to as in-band approach. The majority of the communications between the mass storage device 199 and the host, such as reading from or writing to the memory devices 120, are carried out by this in-band approach.

The mass storage device controller 100 may also include a wired sideband interface 104 in communication with the controller processor 101. The mass storage device controller 100 may be configured to transmit to or receive information from a device (not shown) external to the mass storage device 199 through the wired sideband interface 104. As previously discussed, the sideband interface 104 may include JTAG interface, a UART interface, a SMBus/I2C interface, etc. The external device can be any suitable devices capable of communicating via the sideband interface 104, such as a computer or a Field-Programmable Gate Array (“FPGA”)-based device. Again, passing information between an external device and the mass storage device 199 through the wired sideband interface 104 is referred to as wired sideband approach.

The mass storage device controller 100 further includes a wireless sideband interface 105 integrated within the mass storage device controller 100 and in communication with the controller processor 101. The wireless sideband interface 105 may also be in communication with any other components of the mass storage device controller 100, as the wireless sideband interface 105, including a wireless sideband interface processor 135, is a part of the mass storage device controller 100 package, the same internal and external connections available to the mass storage device controller 100 may be equally available to the wireless sideband interface 105. The wireless sideband interface processor 135 can be any processor suitable for facilitating wireless communication, such as an internet-of-things (“IoT”) processor.

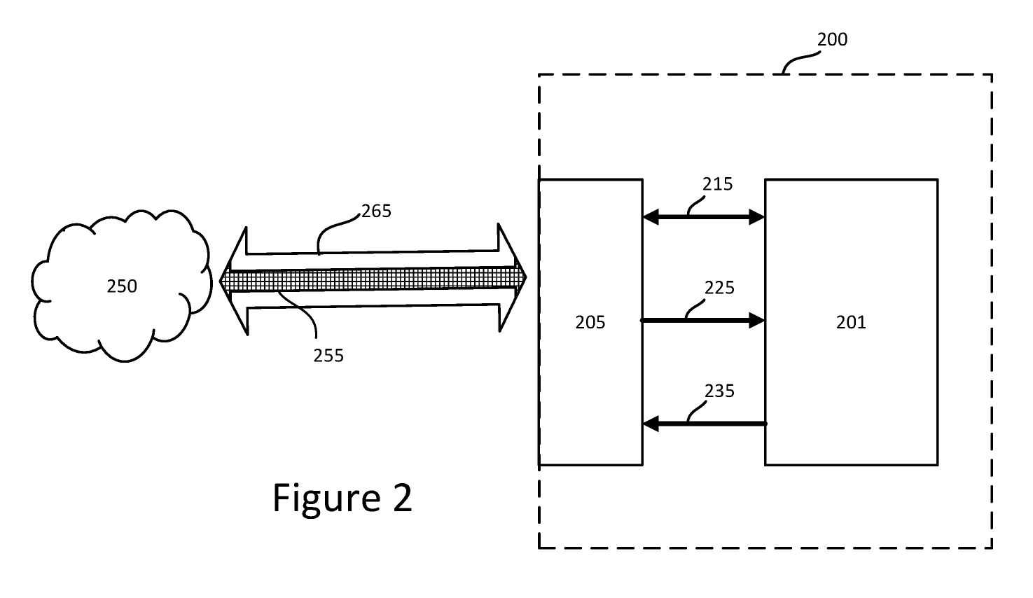

The configuration and implementation of the wireless sideband interface 105 is discussed in greater detail in connection with FIG. 2, below. While integrating a wireless sideband interface 105 into the mass storage device controller 100 means adding complexity to both the physical design of the mass storage device controller 100 and the firmware required to operate the mass storage device controller, and adding an increased physical footprint and power consumption as compared to a similarly configured mass storage device controller without the wireless sideband interface 105, the benefits provided by integrating the wireless sideband interface 105 into the mass storage device controller 100 outweigh these drawbacks, as will be explained in greater detail below.

In operation, the wireless sideband interface processor 135 retrieves various internally generated operating information of the mass storage device 199 from the controller processor 101, processes the information for wireless transmission, and has the wireless sideband interface 105 to wirelessly transmit the information. In one embodiment, the wireless sideband interface processor 135 may directly collect internally generated operating information related to the various components that make up the mass storage device 199. The operation of the wireless sideband interface 105 and the wireless sideband interface processor 135 is explained in greater detail in FIGS. 2-5, below. Such operating information can provide insight into the condition and performance of the mass storage device 199 without the need for physically connecting an external device to the mass storage device 199 or using up the limited in-band bandwidth between the host and the mass storage device 199.

In one embodiment, the internally generated operating information may include I/O statistics collected by the mass storage device controller processor 101 when read and write operations are performed by the mass storage device 199. Examples of such I/O statistics include the average service time for an I/O request, average queue length of the requests issued to the mass storage device 199, number of outstanding I/O requests, and latency of the I/O requests. Monitoring I/O statistics of the mass storage device 199 may reveal any bottlenecks during operation, and may help determine the cause of the bottlenecks so they can be resolved. Further, in a data center with tens to thousands of mass storage devices 199, collecting I/O statics from each mass storage device 199 can identify any mass storage devices 199 that are over-utilized or under-utilized so that the overall usage or load of the mass storage devices 199 can be balanced throughout the data center.

In another embodiment, the internally generated operating information may include error information indicating an error has occurred during the operation of the mass storage device 199. Many different types of errors may arise during the operation of the mass storage device 199. For example, read and write errors may occur when an attempt to read data from or write data to one or more memory devices 120 fails. A data retention error may occur when the data stored in the memory devices unintentionally changes over time. Other errors related to the various components that make up the mass storage device 199 may also be collected by the controller processor 101 and retrieved by the wireless sideband interface processor 135.

As previously mentioned, the wireless sideband interface 105 may directly retrieve operating information, including error information, for the various components that make up the mass storage device 199, including the mass storage device controller 100. This is particularly useful in the case where a processor core of the controller processor 101 fails, rendering the controller processor 101 non-functional. In this case, traditional approaches, such as the wired sideband and in-band approaches, will be unworkable because as previously discussed, the controller processor 101 manages the operation of the host interface 103 and the wired sideband interface 104. As the wireless sideband interface 105 contains its own wireless sideband interface processor 135, even if the controller processor 101 becomes non-functional thereby rendering the mass storage device controller 100 non-functional, the wireless sideband interface 105 may still be able to collect error information regarding the internal components of the mass storage device 199, including the internal components of the mass storage device controller 100, such as a processor core failure within the controller processor 101, and wirelessly transmit that information externally out of the mass storage device 199.

The error information may also include metrics indicating the frequency and extent of errors during the operation of a mass storage device. For example, the controller processor 101 may collect read error count, write error count, spin-retry count (for HDDs), specific memory device failures, etc.

In yet another embodiment, the internally generated operating information includes temperature and power consumption information of the mass storage device 199. The controller processor 101 or the wireless sideband interface 105 can typically gather such information through various sensors 106 located within the mass storage device 199. Such information may be useful to monitor the overall health and performance of the internal components of the mass storage device 199 to ensure that they are operating within expected parameters.

The type of information retrievable by the wireless sideband interface 105 is not limited to internally generated operating information, that is, information generated during the operation of the mass storage device 199. For example, in one embodiment, when the mass storage device 199 is powered off or otherwise inoperative, the wireless sideband interface 105 via its wireless sideband interface processor 135 may nonetheless retrieve information indicating that the mass storage device 199 is inoperative, and may wirelessly transmit this information to an external destination.

The wireless sideband interface 105 is not limited to sending wireless transmissions. In operation, the wireless sideband interface 105 may also wirelessly receive information. The wireless sideband interface processor 135 processes the wirelessly received information and may communicate the information to the controller processor 101 for further processing. Various types of information may be wirelessly received by the wireless sideband interface 105. For example, in one embodiment, the wireless sideband interface 105 may wirelessly receive information containing an instruction to shut down the mass storage device 199. Subsequently, the wireless sideband interface processor 135 processes the information and communicates the “shut down” instruction to the controller processor 101 to be executed. In another embodiment, the wireless sideband interface 105 may wirelessly receive information containing a series instructions and data for upgrading a firmware of the mass storage device 199. The wireless sideband interface processor 199 similarly processes the information and communicates the instructions and data to the controller processor 101 to perform the firmware upgrade.

Further, the wireless sideband interface 105 may be used to perform a series of operations involving the mass storage device 199. For example, the wireless sideband interface 105 may wirelessly receive information from an external source containing a request for temperature information of the components of the mass storage device 199. The wireless sideband interface 105 communicates the request to the controller processor 101 or may directly gather the information from the various sensors 106 within the mass storage device 199. If the request is made to the controller processor 101, then the controller processor 101 executes the request by gathering the temperature information from the sensors 106. Subsequently, the wireless sideband interface processor 135 retrieves the temperature information from the controller processor 101, or directly from the various sensors 106, and the wireless sideband interface 105 wirelessly transmits the temperature information to the external source.

Similarly, in another example, the wireless sideband interface 105 may wirelessly receive information from an external source containing debugging commands. The wireless sideband interface 105 may communicate the debugging commands to the controller processor 101, or may execute the debugging commands directly using the wireless sideband interface processor 135. The controller processor 101, or the wireless sideband interface processor 135, executes the debugging commands. After executing the commands, the wireless sideband interface 105 retrieves any information returned as a result of the debugging commands and wirelessly transmits that information to the external source.

In one embodiment, the mass storage device 199 includes a power source 170 that supplies power to the various components of the mass storage device 199, including the mass storage device controller 100 and the memory devices 120. The power source 170 may be provided by the host device via a connector or pins connecting the host device and the mass storage device 199, or the power source 170 may be directly provided by an external source such as a power outlet connected to the mass storage device 199 via a power adapter. The power source 170 may also be an internal power supply within the mass storage device 170, such as a battery or capacitor, or any combination of internal/external power supplies.

While the wireless sideband interface 105 may derive power from the mass storage device power source 170, in one embodiment, the wireless sideband interface 105 may derive power from a power source 145 that is independent from the power source 170 providing power to the entire mass storage device 199. Similar to the mass storage device power source 170, the power source 145 may be any suitable internal or external power supply, or any combination thereof. Independently powering the wireless sideband interface 105 has a number of benefits. For example, when the mass storage device 199 is powered off or otherwise does not receive any power through the mass storage device power source 170, the wireless sideband interface 105 may be configured to be turn on the mass storage device 199 by wirelessly receiving a “wake-up” instruction, processing that instruction, and sending that instruction to the controller processor 101 to activate the mass storage device 199. In another example, when the mass storage device 199 is inoperative due to power loss, the wireless sideband interface 105 may be configured to report such power loss by wirelessly transmitting information indicating that the mass storage device 199 is inoperative.

FIG. 2 is a block diagram of a mass storage device controller 200 wirelessly communicating with a wireless network 250 through a wireless sideband interface 205, according to one embodiment of the invention. As previously described in connection with the mass storage device 199 shown and described in FIG. 1, the wireless sideband interface 205 may be included within the mass storage device controller 200 and communicatively coupled with the mass storage device controller processor 201. In operation, the wireless sideband interface 205 communicates interface initialization information 215 with the controller processor 201. The wireless sideband interface may also retrieve information 235 from the controller processor 201, process the information, and wirelessly transmit the processed information to a wireless network 250. The wireless sideband interface 205 may also wirelessly receive information, process the information, and communicate the processed information 225 to the controller processor 201.

The processing engaged by the wireless sideband interface 205 for a wireless transmission or a wireless reception depends on the type of wireless communication technology involved. The wireless transmission or reception may be achieved through different suitable wireless network technology, such as IEEE 802.11x family of wireless protocols (also known as Wi-Fi), Bluetooth Low Energy (BLE), cellular communication, ZigBee, Z-Wave, etc., and a number of different network protocols, such as MQTT, CoAP, HTTP, etc. For example, wireless sideband interface 205 may be equipped with IEEE 802.11 Wi-Fi connectivity and use the MQTT protocol. MQTT is a publish/subscribe type protocol that can securely send and receive small messages over the Transmission Control Protocol (TCP)/Internet Protocol (IP) stack. It is a very lightweight protocol that is both bandwidth efficient and energy efficient.

In this example, in a wireless transmission operation, the wireless sideband interface 205 may processes the retrieved information 235 by formatting the information into packets conforming to MQTT protocols. This typically involves encapsulating the information with appropriate MQTT header, and the like. Subsequently, the wireless sideband interface 205 further processes the information 235 by further encapsulating the information with proper TCP header and IP header. Subsequently, the processed information that now includes a MQTT layer 255 and a TCP/IP layer 265, is wirelessly transmitted to a wireless network 250. The wireless sideband interface 205 may further encrypt or decrypt the information 235, if such features are desired.

Similarly, in a wireless reception operation, the wireless sideband interface 205 may wirelessly receive information with a MQTT layer 255 and a TCP/IP layer 265. The wireless sideband interface 205 processes the information by first decapsulating the TCP/IP layer 265 of the received information, and then decapsulating the MQTT layer 255. Subsequently, the wireless sideband interface 205 communicates the processed information 225 to the controller processor 215.

The deployment of wireless communication technology makes it possible and convenient to access information from or deliver information to a mass storage device. With the built-in wireless connectivity provided by the wireless sideband interface 205, a mass storage device according to the present invention can be accessed from anywhere in the world.

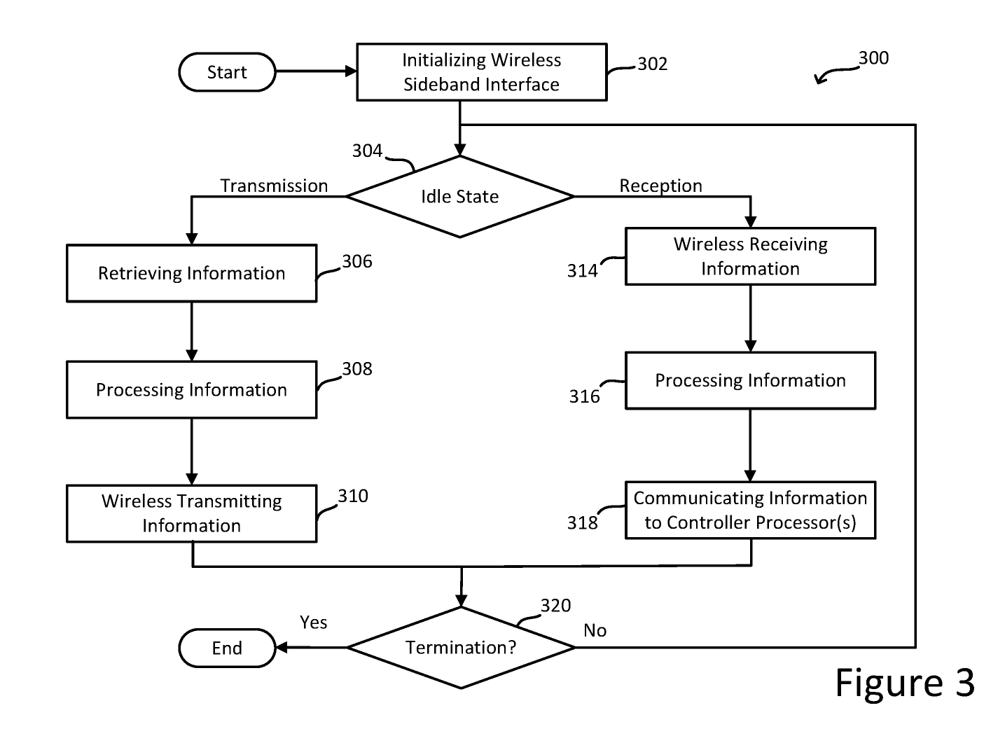

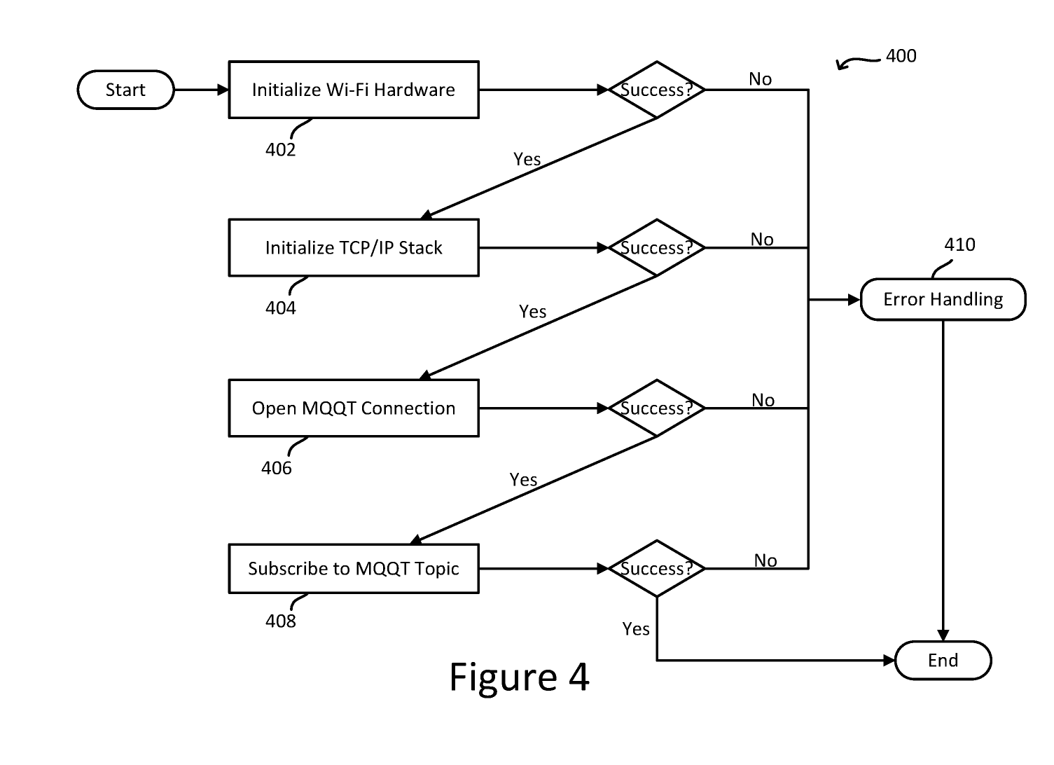

FIG. 3 shows a flowchart 300 detailing steps for performing a transmission and a reception operation using a wireless sideband interface of a mass storage device, according to one embodiment of the invention. At step 302, a wireless sideband interface is initialized. For example, the wireless sideband could be the wireless sideband interface 105 shown and described in connection with FIG. 1 or the wireless sideband interface 205 shown and described in FIG. 2. This initialization step will be discussed in greater detail below in connection with FIG. 4.

At step 304, the wireless sideband interface stays in an idle state until either a transmission operation or a reception operation is invoked. For instance, a transmission operation may be invoked based on the programming of a firmware controlling the wireless sideband interface, or it may be invoked by a mass storage device controller in communication with the wireless sideband interface. If a transmission operation is invoked at step 304, the wireless sideband interface retrieves information regarding the mass storage device at step 306 (i.e., either through a controller processor of the mass storage device controller, or directly from the various components of the mass storage device). At step 308, the wireless sideband interface processes the information for wireless transmission, such as formatting and encapsulating the information based on the specific network technology and protocols used by the wireless sideband interface, for example, as described in connection with FIG. 2. At step 310, the wireless sideband interface wirelessly transmits the processed information to a desired destination, which may be external to the mass storage device.

A reception operation may be invoked, for example, based on the firmware of the wireless sideband interface, or when the wireless sideband interface detects a wireless transmission to be received. If a reception operation is invoked, the wireless sideband interface processor first wirelessly receives the information at step 314. At step 316, the sideband interface processor processes the wirelessly received information. In one embodiment, as previously described in connection with FIG. 2, the processing of the received information may include decapuslating transport layers used for the wireless transmission and the like. At step 318, the wireless sideband interface communicates the processed information to one or more controller processors for further processing.

After step 310 or step 318, the wireless sideband interface determines if the wireless interface is to be terminated at step 320. If yes, then the wireless sideband interfaces shut off until it is initialized again. If not, the wireless sideband interface returns to the idle state of step 304.

FIG. 4 shows a flowchart 400 for initializing a wireless sideband interface, according to one embodiment of the invention. As previously explained, the exact steps necessary to initialize the sideband interface depends on the type of wireless communication technology utilized. The embodiment shown in FIG. 4 describes the process of initializing a wireless sideband interface equipped with IEEE 802.11 Wi-Fi technology and the MQTT protocol. Again, MQTT is a publish/subscribe type protocol over the TCP/IP stack that has a client-broker structure. Disclosure of one example is given for the sake of brevity. However, other suitable wireless technology and protocols may also be used and is within the scope of the present invention. Indeed, it is well within the knowledge of one of ordinary skill in the art to customize the steps shown here for other wireless communication technology and protocols.

At step 402, the wireless sideband interface hardware (i.e. the wireless sideband interface processor, transmission/reception hardware, dedicated power supply, etc.) is initialized. If the wireless sideband interface hardware is successfully initialized, then at step 404 the wireless sideband interface initializes a TCP/IP stack. If the TCP/IP stack is successfully initialized, then at step 406 the wireless sideband interface opens the MQTT connection. For example, this is achieved by the wireless sideband interface sending a MQTT CONNECT command message to a MQTT broker. If the wireless sideband interface receives a CONNACK message in return, this means the MQTT connection is successfully opened. If the MQQT connection is successfully opened, then at step 408 the wireless sideband interface subscribes to a MQTT topic at step 408. A topic, may be, in one example a string within the MQTT message that is used by the broker to forward the message to interested clients. Generally, every MQTT message contains a topic. By subscribing to a specific topic, the wireless sideband interface will be able to wireless receive any MQTT message containing that topic string.

If the wireless sideband interface is unsuccessful at any of the steps 402-408, the wireless sideband interface will perform error handling (e.g., at step 410). The error handling step 410 can be as simple as having an LED light indicating that the attempt to initialize the wireless sideband interface has failed. Alternatively, more complex error collection and correction operations, such as network debugging and troubleshooting, may be pre-programed for the wireless sideband interface.

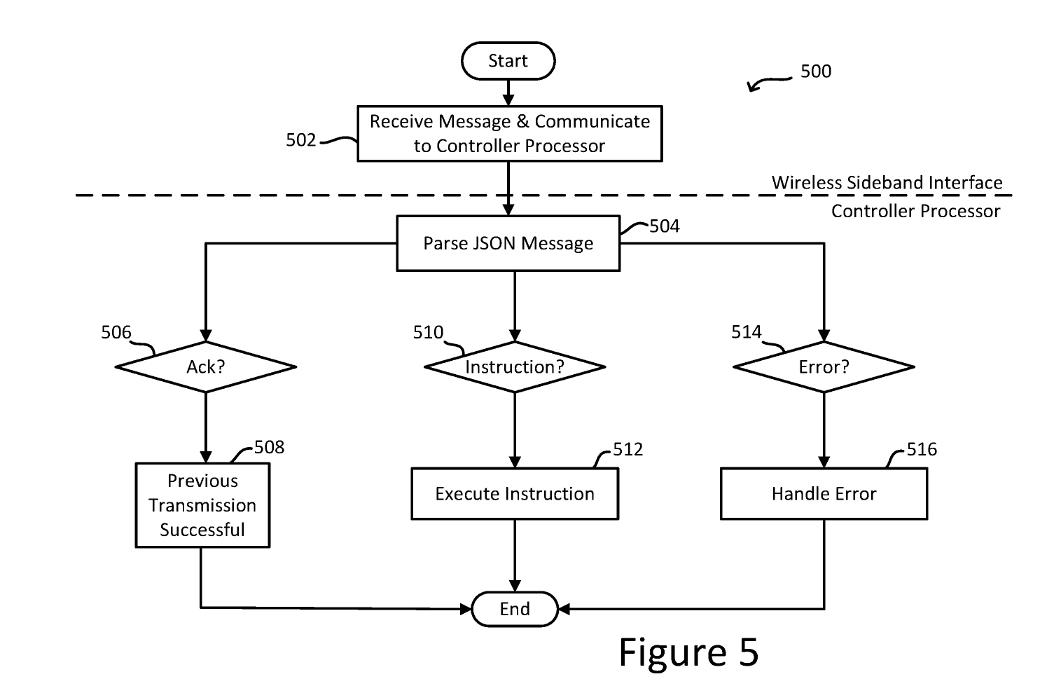

FIG. 5 shows a flowchart 500 for wirelessly receiving and processing information with a wireless sideband interface, according to one embodiment of the invention. As shown in the example of FIG. 5, at step 502, the wirelessly received information contains a Java Script Object Notation (JSON) message, and communicates the information to a controller processor of a mass storage device controller, for example, as previously described in connection with FIGS. 1-3. While FIG. 5 depicts an example using JSON, in one or more embodiments, the wireless sideband interface can also handle other types of data, such as binary data, textual data, and XML data, etc.

At step 504, the controller processor first parses the JSON messages to determine what type of information is contained in the message (e.g., acknowledgement, instruction, error, etc.). For example, as shown in step 506, if the mass storage device has previously transmitted a message, the information obtained in step 504 may an acknowledgement from the recipient that the message was received. In this case, the controller processor will register that the previous transmission operation was successful at step 508.

Or, as shown in step 510, the information obtained in step 504 may contain one or more instructions. In this case, the controller processor may execute the one or more instructions at step 512. If the message received is not recognized nor understood, then in step 514, the information obtained may be an error or unrecognizable information. In this case, the controller processor will perform an appropriate error handling at step 516. The error handling may be as simple as discarding the error information. More complex error handing operations are also possible and within the scope of this disclosure.

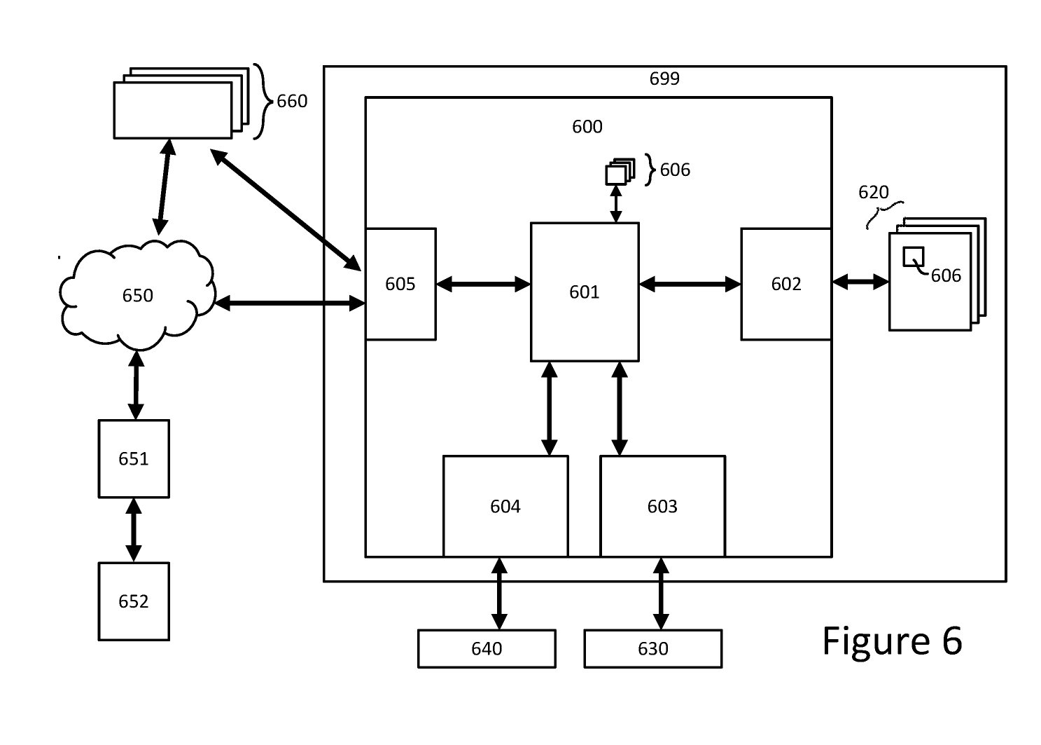

FIG. 6 is a block diagram of a plurality of mass storage devices 660 and 669 communicating wirelessly with a network 650 through respective wireless sideband interfaces, according to one embodiment of the invention. As shown in FIG. 6, mass storage devices 660 and 699 may communicate with the wireless network 650. For simplicity, the components of the mass storage devices 660 are not shown, however, each of the plurality of mass storage devices 660 may contain similar components as shown in the mass storage device 699.

In one embodiment, the mass storage device 699 may be similar to the mass storage device 199 shown and described in connection with FIG. 1. The mass storage device 699 may include a mass storage device controller 600 communicatively coupled to one or more memory devices 620. The mass storage device controller 600 may further include a controller processor 601 and a memory controller 602 configured to manage the one or more memory devices 620. The mass storage device controller processor 601 may be communicatively coupled to a host 630 through a host interface 603. The host interface 603 may be a PCIe interface, a SATA interface, a SAS interface, a SCSI interface, or any other interface suitable for facilitating communication between the host 630 and the mass storage device 699. As previously discussed, the host 630 may be a personal computer, a storage appliance, or any other suitable device.

The mass storage device controller 600 may also be configured to connect to and communicate with an external device 640 through a wired sideband interface 604. The wired sideband interface 604 may be a JTAG interface, a UART interface, a SMBus/I2C interface, etc. The external device 640 may be any suitable device capable of communicating with the mass storage device controller 600 via the wired sideband interface 604, such as a computer or an FPGA-based device. The mass storage device 699 may further include one or more sensors 606 connected to one or more of the components of the mass storage device 699. The sensors 606 may collect information from the components that they are attached to, such as temperature or power consumption.

The mass storage device 699 is configured to wirelessly communicate with a network 650 through a wireless sideband interface 605 contained within the mass storage device controller 600. Other mass storage devices 660 may be configured to wirelessly communicate with the network 650 in a similar manner. The wireless network 650 may be connected to a network server 651, which may be further connected to a server 652 configured to perform different operations, such as conducting data analysis on information obtained from the mass storage device 699 and the other mass storage devices 660. The network 650 may be a public wide area network (such as an open cloud network) or a private network (such as a closed cloud network or a local area network).

The mass storage devices 660 and 699 may be configured to periodically transmit internally generated operating information to the server 652 via the network 650. The wireless sideband interface 605 of the mass storage devices 660 and 699 collects the internally generated information, and wirelessly transmits the information to the network 650. As previously discussed, this internally generated operating information can include a variety of information related to the operation of the mass storage devices 660 and 699, including error information, such as read error count, write error count, spin-retry count (for HDDs), information regarding memory device failures, etc. Other internally generated information may include I/O statistics, temperature and power consumption information, and the like.

The server 652 may process the internally generated information wirelessly transmitted over the network 650 to monitor the condition of the mass storage devices 660 and 699 to ensure that each of the mass storage devices 660 and 699 and their respective internal components are operating within predefined parameters (i.e. within a specified operating temperature or power consumption, within a an acceptable error rate, having desired I/O performance, etc.). The server 652 may be configured to troubleshoot or debug any issues that are detected from the information that is wirelessly transmitted by the wireless sideband interfaces 605 of the mass storage devices 660 and 699. The server 652 may further compile statistics based on the wirelessly received internally generated operating information of the mass storage devices 660 and 699, which in turn can be used to perform data analytics to generate trend information regarding the performance and health of the mass storage devices 660 and 699.

In one embodiment, the mass storage device 699 and the other mass storage devices 660 are further configured to transmit unique identification information along with internally generated operating information via the wireless sideband interface 605 to the network 650. By including such information, the server 652 may identify the specific operational information attributable to each of the mass storage devices 660 and 699. For example, the unique identifying information can be used to locate an inoperative or failing mass storage device within the plurality of mass storage devices 660, and troubleshooting or debugging commands can be selectively sent to the failing or inoperative mass storage device.

As previously discussed, the mass storage devices 660 and 699 are also capable of wirelessly receiving information via their respective wireless sideband interfaces 105. For example, the server 652 may be configured to “survey” the performance of the mass storage devices 660 and 699 by sending a request for certain internally generated operating information through the network server 651 and network 650, which distributes the request to each of the mass storage devices 660 and 699. The mass storage devices 660 and 699 receive the request through their respective wireless sideband interfaces 605, and the mass storage device controller processor 601 or the wireless sideband interface 605 processes the command and gathers the requested information. Subsequently, the wireless sideband interface 605 wirelessly transmits the gathered information back to the requesting server 652 through the network 650 and the network server 651.

This wireless communication mechanism can be used to efficiently manage a large or distributed data center by carrying out various tasks wirelessly. For example, the firmware of the mass storage devices 660 and 699 can be remotely updated by wirelessly transmitting the updated firmware to the mass storage devices 660 and 699 via their respective wireless sideband interfaces 605. Moreover, any of the mass storage devices 660 and 699 can be remotely shut down to address concerns like overheating. The workload distribution of the mass storage devices 660 and 699 can also be coordinated to balance the load on each of the mass storage devices 660 and 699.

In one embodiment, mass storage devices 660 may communicate wirelessly with mass storage device 699 (and vice versa) via respective sideband interfaces 605, either directly or through the network 650. This allows the mass storage devices 660 and 699 to transceive internally generated information to/from one another. In this manner, the mass storage devices 660 and 699 may be further configured to be self-regulating, coordinating amongst themselves to perform load balancing or other types of actions without server 652.

Other objects, advantages and embodiments of the various aspects of the present invention will be apparent to those who are skilled in the field of the invention and are within the scope of the description and the accompanying Figures. For example, but without limitation, structural or functional elements might be rearranged, or method steps reordered, consistent with the present invention. Similarly, principles according to the present invention could be applied to other examples, which, even if not specifically described here in detail, would nevertheless be within the scope of the present invention.

1. A mass storage device comprising:
one or more memory devices; and
a mass storage device controller communicatively coupled to the one or more memory devices, the mass storage device controller including one or more controller processors and a wireless sideband interface, wherein
the wireless sideband interface includes an interface processor in communication with at least one of the controller processors, and the wireless sideband interface is configured to wirelessly transmit a first information retrieved by the interface processor from one of the controller processors or one of the memory devices.

2. The mass storage device of claim 1, further comprising
one or more sensors in communication with the at least one of the controller processors or the wireless sideband interface, wherein
the at least one of the controller processors or the wireless sideband interface is configured to gather the first information from the one or more sensors.

3. The mass storage of claim 1, further comprising:
a first power source and a second power source, wherein
the first power source is configured to provide power to the mass storage device, and
the second power source is configured to provide power to the wireless sideband interface.

4. The mass storage device of claim 1, wherein
the wireless sideband interface is further configured to wirelessly receive a second information, and
the interface processor is configured to communicate the second information to one of the controller processors.

5. The mass storage device of claim 4, wherein
the second information includes one or more instructions, and
one of the controller processors is configured to execute the one or more instructions.

6. The mass storage device of claim 1, wherein the interface processor is an internet-of-things (IoT) processor.

7. The mass storage device of claim 4, wherein the wireless sideband interface is configured to encapsulate the first information in accordance with a wireless network protocol, and to decapsulate the second information in accordance with the wireless network protocol.

8. The mass storage device of claim 7, wherein the wireless network protocol is a Message Queue Telemetry Transport (MQTT) protocol, a Constrained Application Protocol (CoAP), or a Hypertext Transfer Protocol (HTTP).

9. The mass storage device of claim 1, wherein the first information includes input/output (I/O) statistics of the mass storage device.

10. The mass storage device of claim 1, wherein the first information includes error information of the mass storage device.

11. The mass storage device of claim 1, wherein the first information includes a temperature information or a power consumption information of the mass storage device.

12. A method of wirelessly transmitting a first information by a mass storage device, the method comprising:
initializing a wireless sideband interface of a mass storage device controller of the mass storage device, the wireless sideband interface having an interface processor in communication with one or more controller processors of the mass storage device controller;
retrieving, by the interface processor, the first information from one of the controller processors within the mass storage device controller or one or more memory devices communicatively coupled to the mass storage device controller;
processing, by the interface processor, the first information for wireless transmission; and
wirelessly transmitting, by the wireless sideband interface, the first information.

13. The method of claim 12, further comprising:
wirelessly receiving, by the wireless sideband interface, a second information,
processing, by the wireless sideband interface, the second information, and
communicating, by the interface processor, the second information to one of the controller processors.

14. The method of claim 13, further comprising:
executing, by one of the controller processors, one or more instructions included in the second information.

15. The method of claim 13, wherein the step of processing the first information for wireless transmission includes encapsulating the first information in accordance with a wireless network protocol, and the step of processing the second information includes decapsulating the second information in accordance with the wireless network protocol.

16. The method of claim 15, wherein the wireless network protocol is a Message Queue Telemetry Transport (MQTT) protocol, a Constrained Application Protocol (CoAP), or a Hypertext Transfer Protocol (HTTP).

17. The method of claim 12, wherein the interface processor is an internet-of-things (IoT) processor.

18. The method of claim 12, wherein the first information includes input/output (I/O) statistics of the mass storage device.

19. The method of claim 12, wherein the first information includes error information of the mass storage device.

20. The method of claim 12, wherein the first information includes a temperature information or a power consumption information of the mass storage device.

21. The mass storage device of claim 1, wherein the mass storage device is a solid state drive (SSD) or a hard disk drive (HDD).

22. The mass storage device of claim 1, wherein,
the wireless sideband interface is further configured to transmit the first information to another mass storage device, and
the first information corresponds to operation characteristics of the mass storage device.

23. The mass storage device of claim 1, wherein,
the mass storage device controller further compromises a host interface, and
the host interface is configured to communicate with the external host device, the host interface corresponding to a Peripheral Component Interconnect Express (PCIe) interface, a Serial AT Attachment (SATA) interface, a Small Computer System Interface (SCSI), or a Serial Attached SCSI (SAS) interface.

24. The mass storage device of claim 23, wherein the mass storage device controller is configured to at least transmit information to, or receive information from, an external host device via the host interface.

25. The mass storage device of claim 1, wherein the interface processor configured to operate independently of the at least one controller processors.

26. The mass storage device of claim 1, wherein the mass storage device controller is configured to at least manage reading from and writing to the one or more memory devices.

27. The method of claim 12, wherein the mass storage device is a solid state drive (SSD) or a hard disk drive (HDD).

28. The method of claim 12, wherein the wireless sideband interface wirelessly transmits the first information to another mass storage device.

29. The method of claim 12, wherein the method further comprises: transmitting the first information according to a side-band approach.

30. The method of claim 12, wherein the method further comprises: transmitting a third information according to an in-band approach.

31. The method of claim 12, wherein the mass storage device controller configured to at least manage reading from and writing to one or more memory devices communicatively coupled to the mass storage device controller and to transmit information to, or receive information from, an external host device via a host interface of the mass storage device controller.

32. The method of claim 31, wherein the method further comprises: transmitting externally, by the host interface, a third information corresponding to data from the one or more memory devices.

33. The method of claim 12, wherein the interface processor is operated independently of the one or more controller processors.

34. The method of claim 12, wherein the first information corresponds to operation characteristics of the mass storage device.
